(19) United States
(12) Patent Application Publication
(10) Pub. No.: US 2011/0059214 A1
(43) Pub. Date: Mar. 10, 2011

(54) METHOD FOR PREPARING BEVERAGES WITH FLAVOR ENHANCING CANDY FRAGMENTS

(76) Inventors: Vincent Argondizzo, Henderson, NV (US); Andrea Argondizzo, Henderson, NV (US)

(21) Appl. No.: 12/556,469

(22) Filed: Sep. 9, 2009

(51) Int. Cl. A23L 2/56; A23G 1/50; A23F 5/46; A23G 3/50; A23L 2/58

(52) U.S. Cl. 426/420

(57) ABSTRACT

A method for enhancing the flavor and color of a beverage with crushed candy fragments is disclosed. The type of candy may be chosen for its color, to contrast, accent, or compliment the color of the beverage. The type of candy may also be chosen for its flavor, to either accent or compliment one or more flavors contained in the beverage. Flavored liquids may also be used to further enhance the flavor of the beverage. The liquids may also be chosen for their color, to contrast, accent, or compliment the color of the beverage.

### FIELD OF THE INVENTION

The present invention is related to making beverages and, more particularly, to a method for preparing beverages with flavor enhancing candy fragments.

### BACKGROUND OF THE INVENTION

Bartenders and servers often apply granulated sugar or salt to the rim of a glass to enhance the flavor and the aesthetics of the drink. For example, a margarita may have granulated salt added to the rim of the margarita glass, to add a salty taste to the margarita. And granulated sugar may be added to the rim of a glass to add a sweet taste to a drink like a Lemon Drop Martini. Colored sugars may also be used to add to the aesthetics of the drink; e.g. using a purple colored sugar for a purple colored specialty drink. However, adding salt or sugar only adds saltiness or sweetness to the drink. The salt or the sugar does not add its own particular flavor. Furthermore, the bartender or server will typically have to order colored sugars from a manufacturer as he/she most likely will not have the time or the equipment to dye regular table sugar.

Lime juice or lemon juice is typically used to wet the rim of the glass before applying sugar or salt to it. But, the flavor of lemon or lime would compliment certain drinks like Lemon Drop Martinis, but would ruin drinks like Chocolate Martinis.

The present invention is a method for enhancing the flavor of drinks with crushed candy fragments. The method may also use flavored liquids to further enhance the flavor of the drink.

### SUMMARY OF THE INVENTION

In accordance with one embodiment of the present invention, a method for preparing a beverage is disclosed. The method comprises the steps of crushing at least one hard candy into fragments, wetting a portion of a beverage container, and applying the candy fragments to the wet portion of the beverage container.

In accordance with another embodiment of the present invention, a method of enhancing a flavor of a beverage is disclosed. The method comprises the step of crushing at least one hard candy into fragments, wherein the at least one hard candy has at least one flavor in common with the beverage, wetting a rim of a beverage container, and applying the candy fragments to the wet rim of the beverage container.

In accordance with another embodiment of the present invention, a method of enhancing a fruit flavored beverage is disclosed. The method comprises the step of crushing at least one hard candy into fragments, the at least one hard candy having at least one fruit flavor in common with the beverage, wetting a rim of a beverage container with an adhesive liquid, and applying the candy fragments to the wet rim of the beverage container.

The foregoing and other objects, features, and advantages of the invention will be apparent from the following, more particular description of the preferred embodiments of the invention, as illustrated in the accompanying drawings.

### BRIEF DESCRIPTION OF THE DRAWINGS

The present invention will become more fully understood from the detailed description and the accompanying drawings, wherein:

FIG. 1 is a perspective view of several wrapped hard candies.

FIG. 2 is a perspective view of the candies of FIG. 1, shown unwrapped and being crushed into fragments by a mallet.

FIG. 3 is an elevated perspective view of the crushed candy fragments of FIG. 2 housed within a drawer of a glass rimmer kit. A margarita glass is also shown being wet with a liquid-soaked sponge housed in the glass rimmer kit before the crushed candy fragments are applied to the rim of the margarita glass.

FIG. 4 is a perspective view of the candies of FIG. 1 shown unwrapped and being crushed into fragments by a grinder.

### DETAILED DESCRIPTION OF THE PREFERRED EMBODIMENTS

The novel features believed characteristic of the invention are set forth in the appended claims. The invention will best be understood by reference to the following detailed description of illustrated embodiments when read in conjunction with the accompanying drawings, wherein like reference numerals and symbols represent like elements.

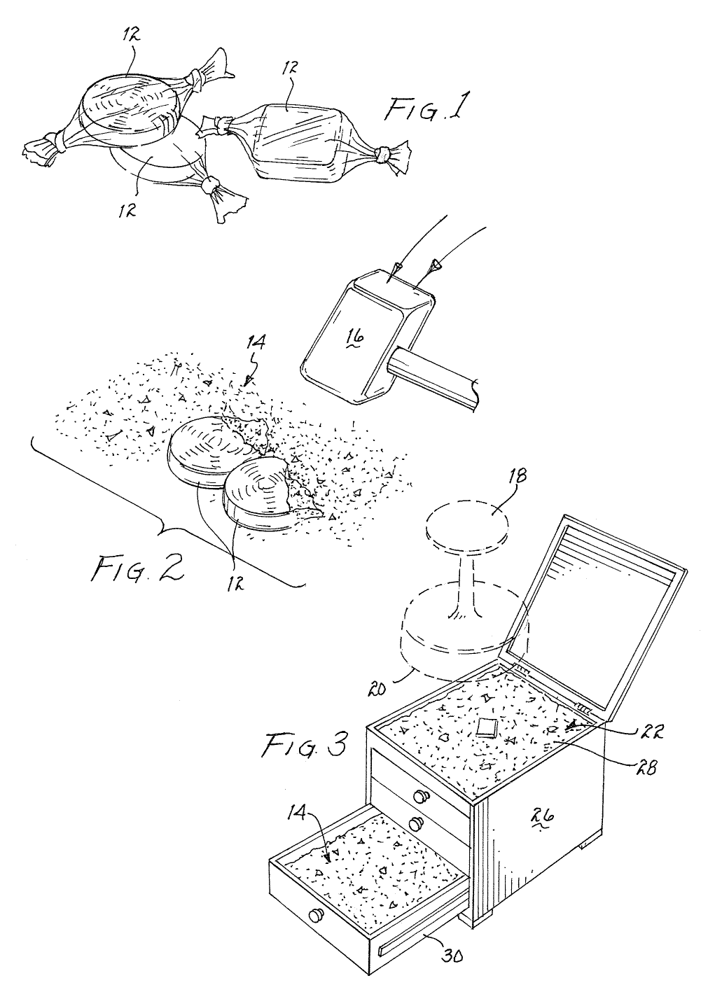

The method of the present invention is shown in FIGS. 1-5. The method comprises the steps of crushing at least one hard candy 12 into fragments 14, wetting a portion of a beverage container 18, and applying the candy fragments 14 to the wet portion of the beverage container 18.

Referring to FIG. 1, a few hard candies 12 are shown. The hard candy 12 may be fruit flavored (e.g. apple, grape, strawberry, cherry, etc.), herb flavored (e.g. licorice, root beer, etc.), spice flavored (e.g. mint, peppermint, spearmint, cinnamon, etc.), chocolate flavored, and coffee flavored. A commonly known hard candy 12 is the JOLLY RANCHER® hard candy. Commonly know fruit flavors made by JOLLY RANCHER® are Grape Cherry, Apple, Blue Raspberry, Watermelon, Lemon, Mountain

Berry, Strawberry, Wild Strawberry, Strawberry-Watermelon, Strawberry-Banana, Raspberry Lemonade, Fruit Punch, Peach, Orange Tangerine, Banana, Banana Pineapple, and Pineapple. A commonly known root beer flavored hard candy 12 is BRACH'S® A&W® Root Beer Barrels and a popular mint flavored hard candy 12 is the BRACH'S® STAR BRITES® Peppermints. A popular coffee flavored hard candy 12 is WEATHERS® ORIGINAL® Caramel Coffee hard candy and a well-known chocolate flavored hard candy 12 is NESTLE® NIPS® Chocolate Parfait hard candies. It should be clearly understood that the aforementioned hard candy brands are examples of hard candies 12 that may be used with the present invention, but it should be clearly understood that substantial benefit may be derived from the use of other hard candy brands and flavors, even homemade hard candies 12.

The hard candy 12 may have at least one color in common with the beverage 10. For example, if the beverage 10 is a purple colored Purple Hooter Martini, a person may select a purple colored hard candy 12 (such as a purple JOLLY RANCHER®) to be paired with the beverage 10 so that it matches the purple color of the beverage 10. A combination of hard candies 12 may also be used for several color combinations; e.g. hard candies 12 with green and white colors may be used to accent a white beverage 10, like a Scooby Snack Martini on St. Patrick's Day holiday. Though the green colored hard candy 12 does not match the white color of the beverage 10, it will accent it.

The hard candy 12 may also have at least one flavor in common with the beverage 10. For example, a BRACH'S® STAR BRITES® peppermint candy may be paired with a Dirty Girl Scout Martini, which has crème de menthe as one of its ingredients. A combination of hard candies 12 may also be used for several flavor combinations; e.g. hard candies 12 with pineapple and cranberry flavors may be used to enhance the flavor of a Bay Breeze Martini, wherein pineapple juice and cranberry juice are ingredients. It is also possible that the hard candy 12 may have both a color and a flavor in common with the beverage 10. For example, a green apple flavored JOLLY RANCHER® may be used for an Apple Martini because its green color will match the green color of the Apple Martini and its apple flavor will enhance the apple flavor of the Apple Martini.

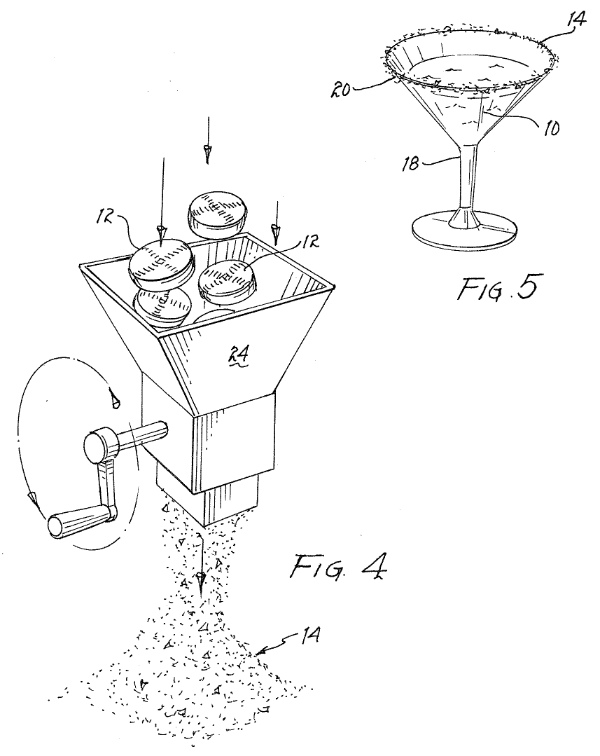

As shown in FIG. 2, the hard candies 12 may be crushed by hand with a mallet 16, hammer, or other instrument. The hard candies 12 may also be crushed with a grinder 24 (shown in FIG. 4), whether the grinder 24 be manually operated or electric. Although these are the two methods shown in the figures, it should be clearly understood that any method or instrument may be used to crush the hard candies 12 into fragments 14.

Referring to FIG. 3, the beverage 10 is typically served in some type of beverage container 18. Oftentimes, specially shaped glasses are used for particular beverages; e.g. a martini glass (see FIG. 5) may be used to serve a martini and a margarita glass (shown in FIG. 3) may be used to serve a margarita. It should be clearly understood, however, that these glasses are used as an example only, and that substantial benefit may be derived from the use of any kind of beverage container regardless or shape or material.

A portion of a beverage container 18 will be wet and the candy fragments 14 will be applied to the wet portion of the beverage container 18. In one embodiment, the rim 20 of the beverage container 18 may be wet so that the candy fragments 14 will be applied to the rim 20 of the beverage container 18. This will allow the person to taste the candy fragments 14 while sipping the beverage 10, ideally enhancing the flavor of the beverage 10. In another embodiment, such as where the beverage container 18 may be a long glass, an inner surface of the beverage container 18 may be wet (above the beverage 10 level) and the candy fragments 14 may be applied to the inner surface of the beverage container 18. The flavor of the candy fragments 14 will combine with the flavor of the beverage 10, ideally enhancing its flavor. It should be clearly understood that substantial benefit may also be derived from the outer surface of the beverage container 18 being wet and the candy fragments being applied to the outer surface of the beverage container 18. This may serve as more of an enhancement of the appearance of the beverage 10.

The beverage container 18 may be wet with an adhesive liquid 22 that helps to bind the candy fragments 14 to the beverage container 18. A commonly used adhesive liquid 22 is ROSE'S® lime juice, however, it should be clearly understood that any edible adhesive liquid 22 may be used. The adhesive liquid 22 may have at least one color in common with the beverage 10. For example, a red colored syrup may be used to wet the beverage container 18 for a Cherry Martini (a red colored beverage 10). The adhesive liquid 22 may also have at least one flavor in common with the beverage 10. For example, cranberry juice may be used to wet the beverage container 18 for a Cosmopolitan Martini because cranberry juice is one of the ingredients of the beverage 10. Furthermore, the adhesive liquid 22 may have both a color and a flavor in common with the beverage 10. For example, brown chocolate syrup may be used to wet the beverage container 18 for a brown colored Chocolate Martini.

The adhesive liquid 22 and/or the candy fragments 14 may be stored in a glass rimer kit 26. Oftentimes, bar tenders or servers use glass rimer kits 26 to keep their work stations clean and organized. The glass rimmer kit 26 may have a sponge 28 soaked with adhesive liquid 22 and compartments 30 for storing the candy fragments 14. It should be clearly understood however, that while convenient, use of such a glass rimmer kit 26 is not required.

FIG. 5 shows a beverage 10 that has been prepared according to the present invention. Candy fragments 14 are shown applied to the rim 20 of a martini glass.

While the invention has been particularly shown and described with reference to preferred embodiments thereof, it will be understood by those skilled in the art that the foregoing and other changes in form and details may be made therein without departing from the spirit and scope of the invention. For example, it should be clearly understood that although alcoholic beverages are mentioned as beverages 10 in the foregoing application, it should be clearly understood that the present invention may be used for non-alcoholic beverages 10 as well. It should also be clearly understood that the invention should not be limited to the specific examples of the colors, flavors, and combinations thereof, mentioned herein. The hard candy 12 may be chosen so that its color contrasts, compliments, or accents one or more of the colors present in the beverage 10. And the hard candy 12 may be chosen so that its flavor contrasts, compliments, or accents one or more of the flavors in the beverage 10. Also, multiple hard candies 12 may be combined to contrast, compliment, and/or accent more than one color or more than one flavor in the beverage 10. Similarly, one or multiple hard candies 12 may be combined to contrast, compliment, and/or accent a color and a flavor in the beverage 10 simultaneously.

What is claimed is:

1. A method for preparing a beverage comprising the steps of:
crushing at least one hard candy into fragments;
wetting a portion of a beverage container; and
applying the candy fragments to the wet portion of the beverage container.

2. The method of claim 1 further comprising the step of providing at least one hard candy that is one of fruit flavored, herb flavored, spice flavored, chocolate flavored, and coffee flavored.

3. The method of claim 1 wherein the at least one hard candy has at least one flavor in common with the beverage.

4. The method of claim 3 wherein the beverage has at least one fruit flavor and the at least one hard candy has at least one fruit flavor in common with the beverage.

5. The method of claim 1 wherein the at least one hard candy has at least one color in common with the beverage.

6. The method of claim 1 wherein the step of crushing the at least one hard candy is performed with a grinding machine.

7. The method of claim 1 wherein the step of crushing the at least one hard candy is performed by hand.

8. The method of claim 1 wherein the step of wetting a portion of the beverage container comprises the step of wetting a rim of the beverage container with an adhesive liquid.

9. The method of claim 8 wherein the adhesive liquid has at least one flavor in common with the beverage.

10. The method of claim 8 wherein the adhesive liquid has at least one color in common with the beverage.

11. A method of enhancing a flavor of a beverage comprising the steps of:
crushing at least one hard candy into fragments, wherein the at least one hard candy has at least one flavor in common with the beverage;
wetting a rim of a beverage container; and
applying the candy fragments to the wet rim of the beverage container.

12. The method of claim 11 wherein the at least one hard candy has at least one color in common with the beverage.

13. The method of claim 11 wherein the at least one hard candy is one of fruit flavored, herb flavored, spice flavored, chocolate flavored, and coffee flavored.

14. The method of claim 11 wherein the rim of the beverage container is wet with an adhesive liquid.

15. The method of claim 14 wherein the adhesive liquid is one of fruit flavored, herb flavored, spice flavored, chocolate flavored, and coffee flavored.

16. A method of enhancing a fruit flavored beverage comprising the steps of:
crushing at least one hard candy into fragments, the at least one hard candy having at least one fruit flavor in common with the beverage;
wetting a rim of a beverage container with an adhesive liquid; and
applying the candy fragments to the wet rim of the beverage container.

17. The method of claim 16 wherein the at least one hard candy has at least one color in common with the beverage.

18. The method of claim 16 wherein the adhesive liquid has at least one fruit flavor in common with the beverage.

19. The method of claim 16 wherein the at least one hard candy has at least one color that accents a color of the beverage.

20. The method of claim 16 wherein the adhesive liquid has at least one color that accents a color of the beverage.
